(19) United States
(12) Patent Application Publication
(10) Pub. No.: US 2012/0278532 A1
(43) Pub. Date: Nov. 1, 2012

(54) DYNAMICALLY CONFIGURABLE EMBEDDED FLASH MEMORY FOR ELECTRONIC DEVICES

(76) Inventor: Wladyslaw Bolanowski, Lund (SE)

(21) Appl. No.: 13/127,156

(22) PCT Filed: Nov. 24, 2010
(86) PCT No.: PCT/IB10/03003

§ 371 Date: May 2, 2011

(51) Int. Cl. G06F 12/02

(52) U.S. Cl. 711/103; 711/E12.008

(57) ABSTRACT

Lifespan of embedded flash memory in an electronic device may be extended and efficient use of the MLC capabilities of the memory may be made by implementing an enhanced partition that stores content that is dynamically adjusted according to the memory usage of the device. The enhanced partition may be used to store data that has a relatively high frequency of updating as measured, for example, by write operations to corresponding memory addresses. In one embodiment, the size of the enhanced partition also may be adjusted in accordance with memory usage, such as basing the size of the enhanced partition on the frequently updated addresses.

### TECHNICAL FIELD OF THE INVENTION

The technology of the present disclosure relates generally to embedded flash memory devices for electronic devices and, more particularly, to a dynamically configurable flash memory for an electronic device, such as a mobile telephone.

### BACKGROUND

There has been a trend in the consumer electronic device industry toward use of embedded flash memory, such as embedded multimedia cards (eMMC). In some devices both system memory and mass storage memory may be resident on the same multilevel cell (MLC) NAND device. In other devices, system memory and mass storage memory may be implemented using separate memory devices.

The lifespan of flash memory tends to be limited by the number of write and erase cycles that the memory cells are subjected to, the size of the memory, how the memory is partitioned, and functionality of the device controller. In general, MLC NAND devices tend to have a lower life length than single level cell (SLC) devices. In order to improve the lifespan of embedded memory, standards promulgated by the Joint Electronic Devices Engineering Council (JEDEC) allow for enhanced partitioning of the embedded memory. Enhanced partition allows critical system components to be stored in an enhanced partition where the cells store data under an SLC approach, while other partitions (referred to as “regular” partitions) store data under an MLC approach. In some circumstances, the lifespan of the enhanced partitions have been found to be about ten times longer than the lifespan of the regular partitions. But MLC is capable of storing data using fewer cells since each cell can retain more data when programmed using multiple program levels than when programmed using a single program level. Depending on the number of programming levels, SLC partitions may consume two or more times the number of cells (and corresponding “silicon area”) than MLC partitions used to store the same amount of data. The present concept of enhanced partition is to statically define the size of the enhanced partition and the regular partition. Therefore, there has been a trade-off between lifespan of embedded flash memory and the data capacity (and corresponding cost) of the embedded flash memory.

### SUMMARY

To extend the lifespan of embedded flash memory (e.g., an MLC NAND configured as an eMMC) in an electronic device and make efficient use of the MLC capabilities of the memory, the present disclosure describes an enhanced partition that stores content (data) that is dynamically adjusted to the memory usage of the device. The enhanced partition may be used to store data that has a relatively high frequency of updating as measured, for example, by write operations to corresponding memory addresses. In one embodiment, the size of the enhanced partition also may be adjusted in accordance with memory usage, such as basing the size of the enhanced partition on the frequently updated addresses.

According to one aspect of the disclosure, an electronic device includes a control circuit having a processor for executing logical instructions; and an embedded flash memory having memory cells that are partitioned into a dynamic enhanced partition in which data is stored using single level cell programming and a second partition in which data is stored using multilevel cell programming, wherein data content that is stored in the dynamic enhanced partition is determined by use of the memory.

According to one embodiment of the electronic device, the data stored in the dynamic enhanced partition is determined by a control function configured to: monitor a number of times addresses of the embedded flash memory are written to; determine if write activity for each monitored address exceeds a threshold for the address and, if so, consider each address with write activity that exceeds the threshold for the address as an active address; and store data associated with each active address in the dynamic enhanced partition.

According to one embodiment of the electronic device, the threshold for addresses in the dynamic enhanced partition is less than the threshold for addresses not in the dynamic enhanced partition.

According to one embodiment of the electronic device, the control function is further configured to move data stored in the second partition and associated with an active address to the dynamic enhanced partition.

According to one embodiment of the electronic device, the control function is further configured to move data stored in the dynamic enhanced partition and not associated with an active address to the second partition.

According to one embodiment of the electronic device, the data stored in the dynamic enhanced partition is adjusted on a periodic basis.

According to one embodiment of the electronic device, write activity is measured as an average number of write operations for each of plural units of time in the period.

According to one embodiment of the electronic device, the embedded flash memory is a multilevel cell NAND memory.

According to one embodiment of the electronic device, the embedded flash memory is an embedded multimedia card.

According to one embodiment of the electronic device, data storage in the dynamic enhanced partition is controlled by the electronic device as a host of the embedded flash memory.

According to one embodiment of the electronic device, data storage in the dynamic enhanced partition is controlled by a logic section that is integrated as part of the embedded flash memory.

According to one embodiment of the electronic device, the second partition is one of a partition in a system memory of the embedded flash memory or a mass storage of the electronic flash memory.

According to one embodiment of the electronic device, a size of the dynamic enhanced partition is determined by use of the memory.

According to one embodiment of the electronic device, the size of the dynamic enhanced partition is determined by a control function configured to: monitor a number of times addresses of the embedded flash memory are written to; determine if write activity for each monitored address exceeds a threshold for the address and, if so, consider each address with write activity that exceeds the threshold for the address as an active address; and reduce a size of the dynamic enhanced partition to accommodate data stored by each active address plus a spare capacity.

According to another aspect of the disclosure, an embedded flash memory for an electronic device includes memory cells that are partitioned into a dynamic enhanced partition in which data is stored using single level cell programming and a second partition in which data is stored using multilevel cell programming, wherein data content that is stored in the dynamic enhanced partition is determined by use of the memory.

According to one embodiment of the embedded flash memory, the data stored in the dynamic enhanced partition is determined by a control function configured to: monitor the number of times addresses of the embedded flash memory are written to; determine if write activity for each monitored address exceeds a threshold for the address and, if so, consider each address with write activity that exceeds the threshold for the address as an active address; and store data associated with each active address in the dynamic enhanced partition.

According to one embodiment of the embedded flash memory, the threshold for addresses in the dynamic enhanced partition is less than the threshold for addresses not in the dynamic enhanced partition.

According to one embodiment of the embedded flash memory, the second partition is one of a partition in a system memory of the embedded flash memory or a mass storage of the electronic flash memory.

According to one embodiment of the embedded flash memory, a size of the dynamic enhanced partition is determined by use of the memory.

According to another aspect of the disclosure, a method of controlling data stored by a dynamic enhanced partition in an embedded flash memory having memory cells that are partitioned into the dynamic enhanced partition in which data is stored using single level cell programming and a second partition in which data is stored using multilevel cell programming includes monitoring a number of times addresses of the embedded flash memory are written to; determining if write activity for each monitored address exceeds a threshold for the address and, if so, consider each address with write activity that exceeds the threshold for the address as an active address; and storing data associated with each active address in the dynamic enhanced partition.

According to one embodiment of the method, the threshold for addresses in the dynamic enhanced partition is less than the threshold for addresses not in the dynamic enhanced partition.

According to one embodiment of the method, the second partition is one of a partition in a system memory of the embedded flash memory or a mass storage of the electronic flash memory.

According to another aspect of the disclosure, a method of controlling a size of a dynamic enhanced partition in an embedded flash memory having memory cells that are partitioned into the dynamic enhanced partition in which data is stored using single level cell programming includes monitoring a number of times addresses of the embedded flash memory are written to; determining if write activity for each monitored address exceeds a threshold for the address and, if so, consider each address with write activity that exceeds the threshold for the address as an active address; and reducing a size of the dynamic enhanced partition to accommodate data stored by each active address plus a spare capacity.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a schematic block diagram of an exemplary electronic device that includes an embedded flash memory;

FIG. 2 is a schematic block diagram of the embedded flash memory;

FIG. 3 is a flow diagram of control operations for dynamically adjusting data stored in an enhanced partition of the embedded flash memory;

FIG. 4 is a flow diagram of steps used to determine which addresses in the embedded flash memory are considered active addresses; and

FIG. 5 is a flow diagram of control operations for dynamically adjusting a size of the enhanced partition of the embedded flash memory.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of dynamically controlling an enhanced partition in an embedded flash memory that is part of an electronic device. In the illustrated embodiments, the electronic device is embodied as a mobile telephone. It will be appreciated that the disclosed techniques may be applied to other operational contexts. Examples of other devices that may be configured in the disclosed manner include, but are not limited to a camera, a navigation device (commonly referred to as a “GPS” or “GPS device”), a personal digital assistant (PDA), a media player (e.g., an MP3 player), a gaming device, and a computing device, and especially those computing devices with a highly portable form factor such as an “ultra-mobile PC” or a “tablet” computer.

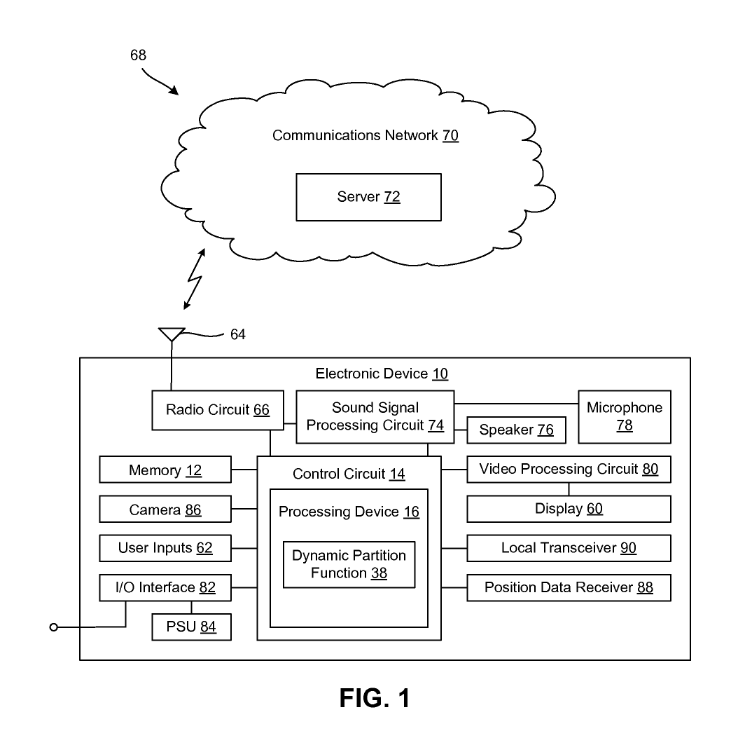

Referring initially to FIG. 1, an electronic device 10 is shown. The illustrated electronic device 10 is a mobile telephone. The electronic device 10 includes a memory device 12. The memory 12 may be used, for example, to store information such as data and program code. In this sense, the memory 12 may be a mass storage device for non-volatile, long term data storage. In one embodiment, the memory 12 also may serve as a system memory for the electronic device 10. In one embodiment, the memory 12 is an embedded flash memory with MLC capability. The memory 12 may be an eMMC flash memory. The memory 12 may have a NAND architecture, but other architectures, including NOR architectures, are possible. Other memory devices may be present, such as one or more of a separate system memory (e.g., random access memory (RAM)), a buffer, an additional flash memory, a hard drive or other magnetic media, an optical memory (e.g., a compact disk (CD) or a digital versatile disk (DVD)), a removable media, a volatile memory, a non-volatile memory, or other suitable memory device.

The electronic device 10 may include a primary control circuit 14 that is configured to carry out overall control of the functions and operations of the electronic device 10. The control circuit 14 may include a processing device 16, such as a central processing unit (CPU), a microcontroller, or a microprocessor. In one embodiment, the processing device 16 executes code stored in the memory 12 in order to carry out operation of the electronic device 10. The memory 12 may exchange data with the control circuit 14 over a data bus. Accompanying control lines and an address bus between the memory 14 and the control circuit 12 also may be present.

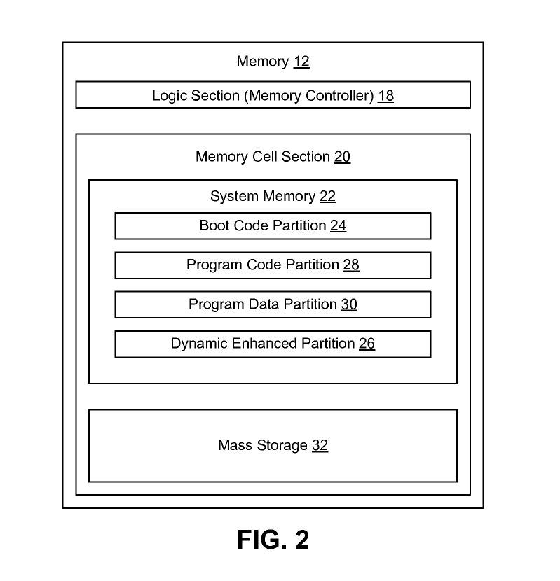

With additional reference to FIG. 2, an exemplary embodiment of the memory 12 is shown in greater detail. It will be appreciated that the memory 12 may be arranged in other manners. Also, the illustrated partitions show the logical arrangement of partitions within the memory and do not indicate relative size of the partitions in terms of pages, memory cells, or other allocation of data storage space. The memory cells in any one partition need not be contiguous in physical arrangement in the memory 12. Each partition may be thought of as a set of addressable memory cells.

The memory 12 includes a logic section 18 (also referred to as a memory controller). The logic section 18 contains circuitry to carry out functional operations of the memory 12, such as write operations, read operations, erase operations, trim operations, and so forth.

The memory 12 further includes a memory cell section 20. The memory cell section 20 may be made up of memory cells, such as the above-noted MLC NAND memory cells. In one embodiment, the memory cell section 20 may include a system memory 22 that functions as a system memory for the electronic device 10 and a mass storage 32 that stores user generated data and other information (e.g., photograph files, video files, temporary Internet files, document files, electronic mail messages, text messages, and so forth). The mass storage 32 also may be referred to as a user memory volume. The system memory 22 may be a super block that is subdivided into two or more partitions, such as, a boot partition 24 that stores boot code for the electronic device 10, a dynamic enhanced partition 26 that is adjustable in size and/or stores frequently updated data, a program code partition 28 that stores executable software programs and an operating system, and a program data partition 30 that stores data that is accessed by the programs.

In one embodiment, the boot partition 24 and the dynamic enhanced partition 26 may be enhanced partitions meaning that data is stored in these partitions using SLC. In one embodiment, each of the program code partition 28, the program data partition 30, and the mass storage 32 may be regular partitions meaning that data is stored in these partitions using MLC. It will be appreciated that, with the exception of the dynamic enhanced partition 26, one or more of the enhanced partitions may be treated as regular partitions and/or one or more of the regular partitions (e.g., the program code partition 28 and the program data partition 30) may be treated as enhanced partitions. The size of a partition may be measured in terms of the number of pages of cells that are allocated to the partition.

As will be described, the data stored by the dynamic enhanced partition 26 and/or the size of the dynamic enhanced partition 26 may change over time depending on usage of the memory 12. The techniques that are used to control the content stored by the dynamic enhanced partition 26 and/or the size of the dynamic enhanced partition 26 also may be applied to other partitions if circumstances permit.

In one embodiment, control over the dynamic enhanced partition 26 may be carried out by the host device, which is the electronic device 10 in the illustrated embodiment. For example, the processing device 16 may execute a dynamic partition function 38 that implements the functions described in this document. The dynamic partition function 38 may be embodied as a set of executable instructions in the form of code, software, or a program that is resident in and executed by the electronic device 10. The dynamic partition function 38 may be a program that is stored on a non-transitory computer readable medium, such as the memory 12. In the following description, an ordered logical flow for the functionality of the dynamic partition function 38 is described. But it will be appreciated that the logical progression may be implemented in an object-oriented or a state-driven manner.

In another embodiment, the control over the dynamic enhanced partition 26 may be carried out by the memory device in which the dynamic enhanced partition 26 is present, which is the memory 12 itself in the illustrated embodiment. For example, the logic section 18 may be configured to implement the functions described in this document, and may include the use of firmware.

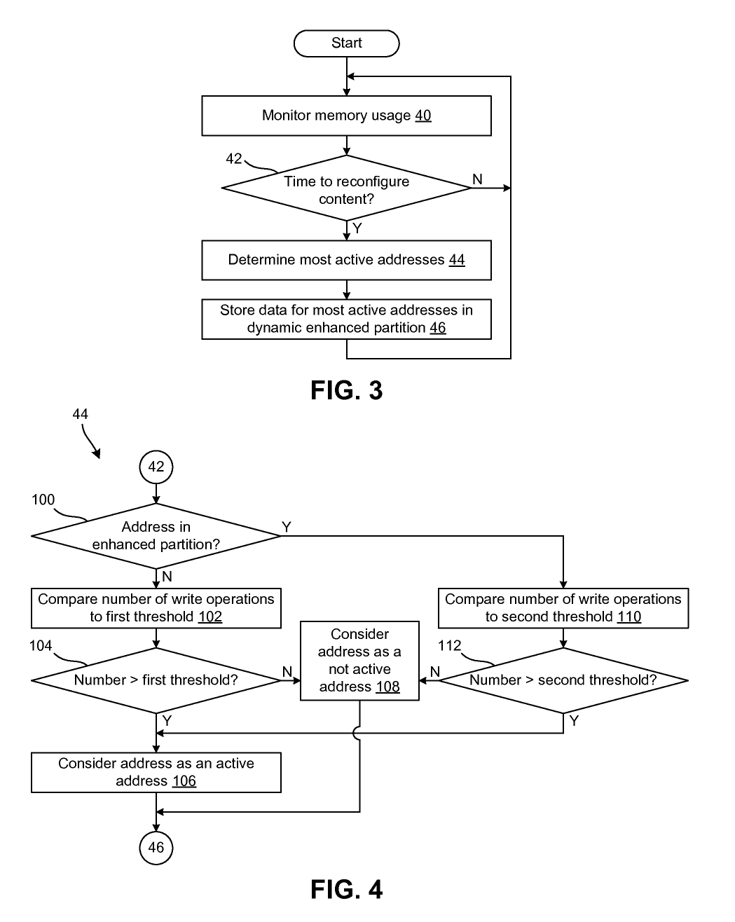

With additional reference to FIGS. 3 through 5, illustrated are logical operations to implement an exemplary method of control over the dynamic enhanced partition 26 in accordance with usage of the memory 12. Portions of the illustrated exemplary method may be carried out by executing the dynamic partition function 38 or may be carried out by the logic section 18, for example. Thus, the flow charts may be thought of as depicting steps of a method carried out by the electronic device 10. Although the flow charts show a specific order of executing functional logic blocks, the order of executing the blocks may be changed relative to the order shown. Also, two or more blocks shown in succession may be executed concurrently or with partial concurrence. Certain blocks also may be omitted.

The logical flow may begin block 40 where use of the memory 12 is monitored. Information collected during the monitoring may include an identification of the logical addresses and amount of data written for each write operation. In one embodiment, the monitoring may be restricted to addresses corresponding to the blocks currently allocated to the dynamic enhanced partition 26, the user memory 42, and any other partition of interest. Therefore, in other embodiments, addresses corresponding to other regular partitions may be included in the monitoring, such as the program data partition 30.

In block 42, a determination may be made as to whether reconfiguration of the content stored by the dynamic enhanced partition 26 should occur. In one embodiment, the elapsing of time since the most recent reconfiguration operation may be used as a trigger in block 42. For instance, a reconfiguration evaluation may be carried out on a periodic basis, such as once a day, once a week, once a month, or on some other interval. Triggers based on parameters other than time also may be employed, such as a number of write operations since the last reconfiguration, a number of updates for an individual address is reached, etc. If a negative determination is made in block 42, memory 12 use monitoring may continue.

If a positive determination is made in block 42, the logical flow may proceed to block 44. In block 44, a determination of which logical addresses are the most active addresses may be made. Determining whether an address is active or not active may be made by comparing the number of write operations for the address over a period of time to a threshold. If the number of write operations equals or exceeds the threshold, the address may be considered active and if the number of write operations is less than the threshold, the address may be considered not active. It will be appreciated a “not active” address may still be the target of write operations over the period of time and need not be a dormant address. It is contemplated that logical addresses related to administration blocks for an operating system, a file management system and/or a database will tend to be the most active. Depending on the nature of the electronic device 10 and how the electronic device 10 is used, the addresses for the administration blocks may not be considered active and/or additional addresses may be considered active.

The period of time over which memory usage is tracked for block 44 may be the same as the time period for the trigger of block 42. Alternatively, the time period may be a different length of time. For instance, the trigger period may be a first duration (e.g., a week) and the number of write operations may be specified as an average number of write operations or other measure of the frequency of write operations that occur during each time period of a second duration (e.g., a day), where the second duration is shorter than the first duration. Using this example, the average number of write operations that take place each day for the address over the last week may be compared to the threshold.

FIG. 4 illustrates a more detailed operation of block 44. In the illustrated embodiment, the number of write operations for addresses in the dynamic enhanced partition 26 are compared to a threshold that is lower than a threshold for addresses outside the dynamic enhanced partition 26. In this manner, a buffer is created to avoid excessive movement of data in and out of the dynamic enhanced partition 26. Rather, once data is stored in the dynamic enhanced partition 26, the data or updated versions of the data will tend to remain in the dynamic enhanced partition 26.

The illustrated operations for block 44 may be iterated for each address that is analyzed and may start in block 100 where a determination is made as to whether the address undergoing analysis is part of the enhanced partition 26. If a negative determination is made in block 100, meaning that the address is not part of the dynamic enhanced partition 26, the logical flow may proceed to block 102. In block 102, the number of write operations for the address (or average number of write operations per unit of time) is compared to a first threshold. If, in block 104, the first threshold is exceeded, the logical flow may proceed to block 106. In block 106, the address undergoing analysis may be considered an active address. If, in block 104, the first threshold is not exceeded, the logical flow may proceed to block 108. In block 108, the address undergoing analysis may be considered not active.

If a positive determination is made in block 100, meaning that the address is part of the dynamic enhanced partition 26, the logical flow may proceed to block 110. In block 110, the number of write operations for the address (or average number of write operations per unit of time) is compared to a second threshold. As indicated, the second threshold may be lower than the first threshold. The first and second thresholds may be predetermined Alternatively, the first and second thresholds may be adjustable based on one or more factors, such as frequency of data updates, an amount of data moved into the dynamic enhanced partition during each reconfiguration, an amount of data moved out of the dynamic enhanced partition during each reconfiguration, repeated movement of the same data (or updated versions thereof) into and out of the dynamic enhanced partition, etc.

If, in block 112, the second threshold is exceeded, the logical flow may proceed to block 106 where the address undergoing analysis may be considered an active address. If, in block 112, the second threshold is not exceeded, the logical flow may proceed to block 108 where the address undergoing analysis may be considered not active.

In block 46, the data associated with the logical addresses that are considered active is moved into the dynamic enhanced partition 26, if not already stored in the dynamic enhanced partition 26. In one embodiment, the moved data may originate from the user memory 32 and/or the program data partition 30. If data is stored using MLC and, following the reconfiguration operation, should now be stored using SLC, then the data may be restored using SLC in accordance with the protocol for data handling in the enhanced partition.

Also, in block 46, data associated with logical addresses that are not considered active, but are within the dynamic enhanced partition 26, may be moved from the dynamic enhanced partition 26 to another partition, such as the user memory 32 or the program data partition 30, and stored using MLC if appropriate. As a result, the dynamic enhanced partition 26 is used to store data associated with logical addresses that are the most active as defined by having update activity that exceeds a threshold.

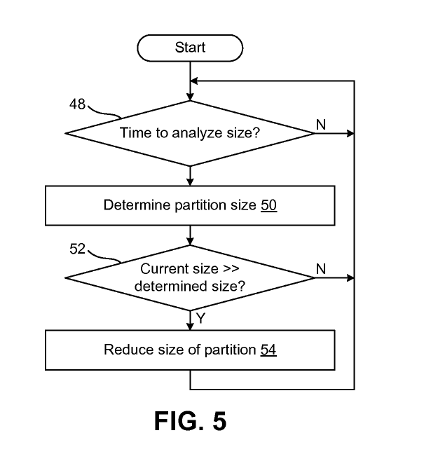

With further reference to FIG. 5, in block 48, a determination may be made as to whether a size analysis of the dynamic enhanced partition 26 should occur. In one embodiment, the size of the dynamic enhanced partition 26 is considered adequate and/or is statically configured. In this case, a negative determination may be made in block 48. In other embodiment, where resizing is a possibility, the elapsing of time since the most recent reconfiguration or resizing analysis may be used as a trigger in block 48. For instance, a resizing evaluation may be carried out on a periodic basis, such as once a day, once a week, once a month, or on some other interval. Triggers based on parameters other than time also may be employed, such as a number of write operations since the last resizing analysis, a number of updates for an individual address is reached, etc.

Following a positive determination in block 48, an appropriate size for the dynamic enhanced partition 26 may be determined in block 50. The size for the dynamic enhanced partition 26 may be determined by ascertaining how many pages would be required to store the data written to the active addresses using SLC data storage.

In block 52, a determination may be made as to whether a current size of the dynamic enhanced partition 26 is significantly greater than the size that is determined in block 50. In one embodiment, the assessment of block 52 is made by determining if the current size is greater than the size determined in block 50 plus a spare capacity amount. The spare capacity amount may be, for example, a predetermined number of pages or a percentage of the number of pages that is determined in block 50. If the current size is greater than the size determined in block 50 plus the spare capacity amount, a positive determination may be made in block 52. Otherwise, a negative determination may be made in block 52 and the logical flow may return to block 48.

If a positive determination is made in block 52, the logical flow may proceed to block 54 where the size of the dynamic enhanced partition 26 is reduced to the size that is determined in block 50 plus the spare capacity amount. In one embodiment, pages that are removed from the dynamic enhanced partition 26 may be assigned to one of the regular partitions, such as the program data partition 30 or the mass storage 32.

Increasing the size of the dynamic enhanced partition 26 may be made as needed to accommodate the data associated with active addresses. Increasing the size of the dynamic enhanced partition 26 may be accomplished by making use of pages reserved for partition expansion purposes.

With continued reference to FIG. 1, the electronic device 10 may include various other components. In the exemplary embodiment of a mobile telephone, the electronic device 10 may include a display 60 for displaying visual content to a user. One or more user input devices 62 may be present. User input devices 62 may include, for example, buttons, a keypad, a touch screen, a pointer, etc.

In addition, the electronic device 10 may include communications circuitry that enables the electronic device 10 to establish communication with another device. Communications may include voice calls, video calls, data transfers, and the like. Communications may occur over a cellular circuit-switched network or over a packet-switched network (e.g., a network compatible with IEEE 802.11, which is commonly referred to as WiFi, or a network compatible with IEEE 802.16, which is commonly referred to as WiMAX). Data transfers may include, but are not limited to, receiving streaming content, receiving data feeds, downloading and/or uploading data (including Internet content), receiving or sending messages (e.g., text messages, instant messages, electronic mail messages, multimedia messages), and so forth. This data may be processed by the electronic device 10, including storing the data in the memory 12, executing applications to allow user interaction with the data, displaying video and/or image content associated with the data, outputting audio sounds associated with the data, and so forth.

In the exemplary embodiment, the communications circuitry may include an antenna 64 coupled to a radio circuit 66. The radio circuit 66 includes a radio frequency transmitter and receiver for transmitting and receiving signals via the antenna 64. The radio circuit 66 may be configured to operate in a mobile communications system 68. Radio circuit 66 types for interaction with a mobile radio network include, but are not limited to, global system for mobile communications (GSM), code division multiple access (CDMA), wideband CDMA (WCDMA), general packet radio service (GPRS), WiFi, WiMAX, integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 64 and the radio circuit 66 may represent one or more than one radio transceiver.

The system 68 may include a communications network 70 having a server 72 (or servers) for managing calls placed by and destined to the electronic device 10, transmitting data to and receiving data from the electronic device 10, and carrying out any other support functions. The communications network 72 may includes transmission mediums through which wireless communications with the electronic device 10 are established. The transmission mediums may be any appropriate device or assembly, including, for example, a communications base station (e.g., a cellular service tower, or “cell” tower), a wireless access point, a satellite, etc. The network 70 may support the communications activity of multiple electronic devices 10 and other types of end user devices. As will be appreciated, the server 72 may be configured as a typical computer system used to carry out server functions and may include a processor configured to execute software containing logical instructions that embody the functions of the server 72 and a memory to store such software. In alternative arrangements, the electronic device 10 may wirelessly communicate directly with another electronic device (e.g., another mobile telephone or a computer) and without an intervening network.

The electronic device 10 further includes a sound signal processing circuit 74 for processing audio signals. Coupled to the sound processing circuit 74 are a speaker 76 and a microphone 78 that enable a user to listen and speak via the electronic device 10, and hear sounds generated in connection with other functions of the device 10. The sound processing circuit 74 may include any appropriate buffers, encoders, decoders, amplifiers and so forth.

The display 60 may be coupled to the control circuit 14 by a video processing circuit 80 that converts video data to a video signal used to drive the display 60. The video processing circuit 80 may include any appropriate buffers, decoders, video data processors and so forth.

The electronic device 10 may further include one or more input/output (I/O) interface(s) 82. The I/O interface(s) 82 may be in the form of typical mobile telephone I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 82 and power to charge a battery of a power supply unit (PSU) 84 within the electronic device 10 may be received over the I/O interface(s) 82. The PSU 84 may supply power to operate the electronic device 10 in the absence of an external power source.

The electronic device 10 also may include various other components. For instance, a camera 86 may be present for taking digital pictures and/or movies. Image and/or video files corresponding to the pictures and/or movies may be stored in the memory 12. A position data receiver 88, such as a global positioning system (GPS) receiver, may be involved in determining the location of the electronic device 10. A local transceiver 90, such as an infrared transceiver and/or an RF transceiver (e.g., a Bluetooth chipset) may be used to establish communication with a nearby device, such as an accessory (e.g., a PHF device), another mobile radio terminal, a computer or another device.

Although certain embodiments have been shown and described, it is understood that equivalents and modifications falling within the scope of the appended claims will occur to others who are skilled in the art upon the reading and understanding of this specification.

1. An electronic device, comprising:
a control circuit having a processor for executing logical instructions; and
an embedded flash memory having memory cells that are partitioned into a dynamic enhanced partition in which data is stored using single level cell programming and a second partition in which data is stored using multilevel cell programming, wherein data content that is stored in the dynamic enhanced partition is determined by use of the memory.

2. The electronic device of claim 1, wherein the data stored in the dynamic enhanced partition is determined by a control function configured to:
monitor a number of times addresses of the embedded flash memory are written to;
determine if write activity for each monitored address exceeds a threshold for the address and, if so, consider each address with write activity that exceeds the threshold for the address as an active address; and
store data associated with each active address in the dynamic enhanced partition.

3. The electronic device of claim 2, wherein the threshold for addresses in the dynamic enhanced partition is less than the threshold for addresses not in the dynamic enhanced partition.

4. The electronic device of claim 2, wherein the control function is further configured to move data stored in the second partition and associated with an active address to the dynamic enhanced partition.

5. The electronic device of claim 2, wherein the control function is further configured to move data stored in the dynamic enhanced partition and not associated with an active address to the second partition.

6. The electronic device of claim 1, wherein the data stored in the dynamic enhanced partition is adjusted on a periodic basis.

7. The electronic device of claim 6, wherein write activity is measured as an average number of write operations for each of plural units of time in the period.

8. The electronic device of claim 1 wherein the embedded flash memory is a multilevel cell NAND memory.

9. The electronic device of claim 1, wherein the embedded flash memory is an embedded multimedia card.

10. The electronic device of claim 1, wherein data storage in the dynamic enhanced partition is controlled by the electronic device as a host of the embedded flash memory.

11. The electronic device of claim 1, wherein data storage in the dynamic enhanced partition is controlled by a logic section that is integrated as part of the embedded flash memory.

12. The electronic device of claim 1, wherein the second partition is one of a partition in a system memory of the embedded flash memory or a mass storage of the electronic flash memory.

13. The electronic device of claim 1, wherein a size of the dynamic enhanced partition is determined by use of the memory.

14. The electronic device of claim 13, wherein the size of the dynamic enhanced partition is determined by a control function configured to:
monitor a number of times addresses of the embedded flash memory are written to;
determine if write activity for each monitored address exceeds a threshold for the address and, if so, consider each address with write activity that exceeds the threshold for the address as an active address; and
reduce a size of the dynamic enhanced partition to accommodate data stored by each active address plus a spare capacity.

15-19. (canceled)

20. A method of controlling data stored by a dynamic enhanced partition in an embedded flash memory having memory cells that are partitioned into the dynamic enhanced partition in which data is stored using single level cell programming and a second partition in which data is stored using multilevel cell programming, comprising:
monitoring a number of times addresses of the embedded flash memory are written to;
determining if write activity for each monitored address exceeds a threshold for the address and, if so, consider each address with write activity that exceeds the threshold for the address as an active address; and
storing data associated with each active address in the dynamic enhanced partition.

21. The method of claim 20, wherein the threshold for addresses in the dynamic enhanced partition is less than the threshold for addresses not in the dynamic enhanced partition.

22. The method of claim 20, wherein the second partition is one of a partition in a system memory of the embedded flash memory or a mass storage of the electronic flash memory.

23. A method of controlling a size of a dynamic enhanced partition in an embedded flash memory having memory cells that are partitioned into the dynamic enhanced partition in which data is stored using single level cell programming, comprising:
monitoring a number of times addresses of the embedded flash memory are written to;
determining if write activity for each monitored address exceeds a threshold for the address and, if so, consider each address with write activity that exceeds the threshold for the address as an active address; and
reducing a size of the dynamic enhanced partition to accommodate data stored by each active address plus a spare capacity.
